(19) United States
(12) Patent Application Publication
(10) Pub. No.: US 2025/0262760 A1
(43) Pub. Date: Aug. 21, 2025

(54) LEARNING VISUAL POSE ESTIMATION FOR ROBOTIC OPERATION

(71) Applicant: FANUC CORPORATION, Yamanashi (JP)

(72) Inventors: Yu Zhao, Santa Clara, CA (US); Tetsuaki Kato, Fremont, CA (US)

(21) Appl. No.: 18/444,841

(22) Filed: Feb. 19, 2024

(51) Int. Cl. B25J 9/16; B25J 19/02

(52) U.S. Cl. CPC B25J 9/163; B25J 9/161; B25J 9/1612; B25J 9/1664; B25J 9/1697; B25J 19/023

(57) ABSTRACT

A method and system for robotic skill learning using visual pose estimation. A robot arm performing a task, such as an assembly or workpiece positioning operation, has a camera mounted thereon. The camera provides training images of an operation scene from a variety of positions and under a variety of lighting conditions. For each image, a relative pose of a tool center point with respect to a target pose is recorded. The images are used in a supervised learning process to train a neural network to minimize a difference between an inferred pose and the relative pose. Once trained, the neural network is used to compute a relative target position which is used in visual servoing control of the robot. The robot may also employ a force controller for final positioning or installation of a workpiece once contact is made with a mating piece.

### BACKGROUND

### Field

The present disclosure relates generally to a method for robot skill learning and, more particularly, to a method for robot visual pose estimation applicable to high precision positioning tasks, where images from a robot arm-mounted camera under different position and lighting conditions are used to train a neural network to infer a pose of a workpiece relative to a target pose, and the trained neural network is then used for visual servoing control of the robot performing the task.

### Discussion of the Related Art

The use of industrial robots to repeatedly perform a wide range of manufacturing and assembly operations is well known. However, some types of tight-tolerance assembly operations, such as installing a peg into a hole or plugging one part into another, are still difficult for robots to perform. These types of operation are often performed manually because robots have difficulty detecting and correcting the complex misalignments that may arise in tight-tolerance assembly tasks. That is, because of minor deviations in part poses due to both grasping and fixturing uncertainty, the robot cannot simply move a part to its nominal installed position, but rather must “feel around” for the proper alignment and fit of one piece into the other.

In order to make assembly tasks robust to these inevitable positioning uncertainties, robotic systems typically utilize force controllers (aka compliance control or admittance control) where force and torque feedback is used to provide motions commands needed to complete the assembly operation. A traditional way to set up and tune a force controller for robotic assembly tasks is by manual tuning, where a human operator programs a real robotic system for the assembly task, runs the program, and adjusts force control parameters carefully in a trial and error fashion. However tuning and set up of these force control functions using physical testing is time consuming and expensive, since manual trial and error has to be performed. Parameter tuning on real physical test systems may also be hazardous, since robots are not compliant, and unexpected forceful contact between parts may therefore damage the robot, the parts, or surrounding fixtures or structures.

Visual servoing control systems are also known which use visual images of an operating environment to guide robot motion. Visual servoing control may be used to guide the robot until part-to-part contact is made, at which point force control takes over. However, in some types of assembly and other operations, it is difficult for visual servoing systems to identify geometric features which can be used for pose detection and correction. Traditional methods often resort to manual teaching of visual servoing systems for feature recognition, or the need for special visual markers to enable more robust recognition of robot position and orientation.

In view of the circumstances described above, improved methods are needed for robotic visual pose estimation, particularly in tight tolerance applications.

### SUMMARY

The following disclosure describes a method and system for robotic skill learning using visual pose estimation. A robot arm performing a task, such as an assembly or workpiece positioning operation, has a camera mounted thereon. The camera provides training images of an operation scene from a variety of positions and under a variety of lighting conditions. For each image, a relative pose of a tool center point with respect to a target pose is recorded. The images are used in a supervised learning process to train a neural network to minimize a difference between an inferred pose and the relative pose. Once trained, the neural network is used to compute a relative target position which is used in visual servoing control of the robot. The robot may also employ a force controller for final workpiece positioning once contact is made with a mating piece.

Additional features of the present disclosure will become apparent from the following description and appended claims, taken in conjunction with the accompanying drawings.

### BRIEF DESCRIPTION OF THE DRAWINGS

FIG. 1 is an illustration of a robotic assembly operation being performed on tight-tolerance parts, illustrating sources of part positioning uncertainty which create challenges for robotic assembly operations;

FIG. 2 is an illustration of parts being robotically assembled, where the parts require alignment in a manner which causes the robot to perform a hole search in a plane perpendicular to the insertion axis;

FIG. 3 is a block diagram illustration of a system configured for a robotic assembly operation using a compliance controller (i.e., force or admittance control), as known in the art;

FIG. 4 is an illustration of a system for learning visual pose estimation in a robotic operation, including data collection for training of a pose estimation neural network, according to an embodiment of the present disclosure;

FIG. 5 is a block diagram illustration of a system configured for learning visual pose estimation in a neural network, using the images and relative pose data from the system of FIG. 4, according to an embodiment of the present disclosure;

FIG. 6 is a block diagram illustration schematically depicting the structure of the visual pose estimation neural network from FIG. 5, according to an embodiment of the present disclosure;

FIG. 7 is a block diagram illustration of a system configured for robotic positioning of a workpiece, using the trained visual pose estimation neural network in a visual servoing controller, according to an embodiment of the present disclosure;

FIG. 8 is a block diagram illustration of a system configured for robotic positioning of a workpiece, using the visual servoing controller of FIG. 7 for preliminary positioning and a compliance controller for final positioning, according to an embodiment of the present disclosure;

FIG. 9 is a block diagram illustration of a system configured for robotic positioning of a workpiece, using integrated compliance control and visual servoing control with the visual pose estimation neural network, according to an embodiment of the present disclosure; and

FIG. 10 is a flowchart diagram of a method for learning visual pose estimation for a robotic operation, including offline training of a neural network using images in different positions and lighting conditions, and online visual servoing using the trained neural network, according to an embodiment of the present disclosure.

### DETAILED DESCRIPTION OF THE EMBODIMENTS

The following discussion of the embodiments of the disclosure directed to a system and method for learning visual pose estimation in robotic operations is merely exemplary in nature, and is in no way intended to limit the disclosed techniques or their applications or uses.

The use of industrial robots for a wide variety of manufacturing and assembly operations is well known. The present disclosure is directed to overcoming the challenges encountered in many robotic operations, such as component assembly, where visual positioning is employed and significant precision is needed in the placement of a workpiece.

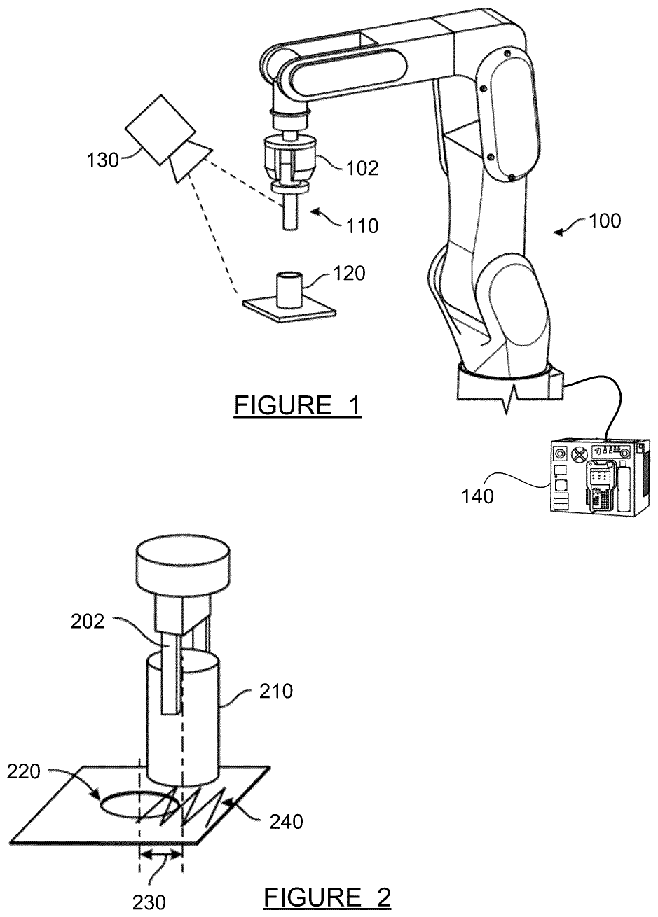

FIG. 1 is an illustration of a robotic assembly operation being performed on tight-tolerance parts, illustrating several sources of part positioning uncertainty which create challenges for robotic assembly operations. A robot 100 having a gripper 102 grasps a first part 110 which is to be assembled with a second part 120. In this example, the first part 110 is a peg part, and the second part 120 is a hole structure. The peg part 110 is to be inserted into a hole in the hole structure 120. The tolerances of the parts in a peg-in-hole assembly are typically quite tight, so that the assembly can operate without excessive looseness after assembled. Some peg-in-hole assemblies have dual coaxial pegs on one part, or dual parallel-axis pegs on one part, which must be simultaneously inserted into dual holes on the other part, which makes the assembly operation even more difficult. Many other types of mating part assemblies—such as electrical connectors, complex planar shapes, etc.—exhibit similarly tight tolerances.

The types of assembly operations described above are often performed manually because robots have difficulty detecting and correcting the complex misalignments that may arise in tight-tolerance assembly tasks. That is, because of minor deviations in part poses, the robot cannot simply move a part to its nominal installed position, but rather must “feel” the alignment and fit of one piece into the other. There are many possible sources of errors and uncertainty in part poses. First, the exact position and orientation (collectively, “pose”) of the peg part 110 as grasped in the gripper 102 may vary by a small amount from the expected pose. Similarly, the exact pose of the hole part 120 in its fixture may also vary from the expected pose. In systems where a camera 130 is used to provide images of the workspace scene for location identification, perception error can also contribute to the uncertainty of relative part positioning. In addition, calibration errors in placement of the robot 100 and the fixture holding the part 120 in the workspace, and minor robot joint position variations, can all further contribute to part positioning uncertainty. These factors combine to make it impossible for the robot 100—controlled by a controller 140—to simply pick up the peg part 110 and insert it in a single motion into the hole structure 120.

FIG. 2 is an illustration of parts being robotically assembled, where the parts require alignment in a manner which causes the robot to perform a hole search in a plane perpendicular to the insertion axis. A gripper 202 grasps a part 210 which must be inserted into a hole 220 in the same manner as shown in FIG. 1. A distance 230, exaggerated for visual effect, represents the uncertainty in the lateral position of the part 210 relative to the hole 220. In order to find the proper alignment of the part 210 with the hole 220, the robot may be required to perform a hole search, where the gripper 202 moves the part 210 back and forth in a zig-zag pattern 240 in a plane which is perpendicular to the axis of the part 210. In systems with camera image input, the distance 230 may be minimized by visual control, but the robot still cannot simply insert the part 210 into the hole 220 in a single motion.

FIGS. 1 and 2 illustrate examples of assembly operations where tight tolerances require great precision in workpiece placement. One known technique which has been developed for use in these types of robotic assembly operations is the use of a force or compliance controller, discussed below. Other types of robotic operations—such as placement of an in-process workpiece into a tool fixture, or placement of a finished part into a form-fitted compartment of a container—similarly require various degrees of workpiece placement precision. In some of these types of operations, compliance control is not appropriate, and accurate visual workpiece placement is preferred.

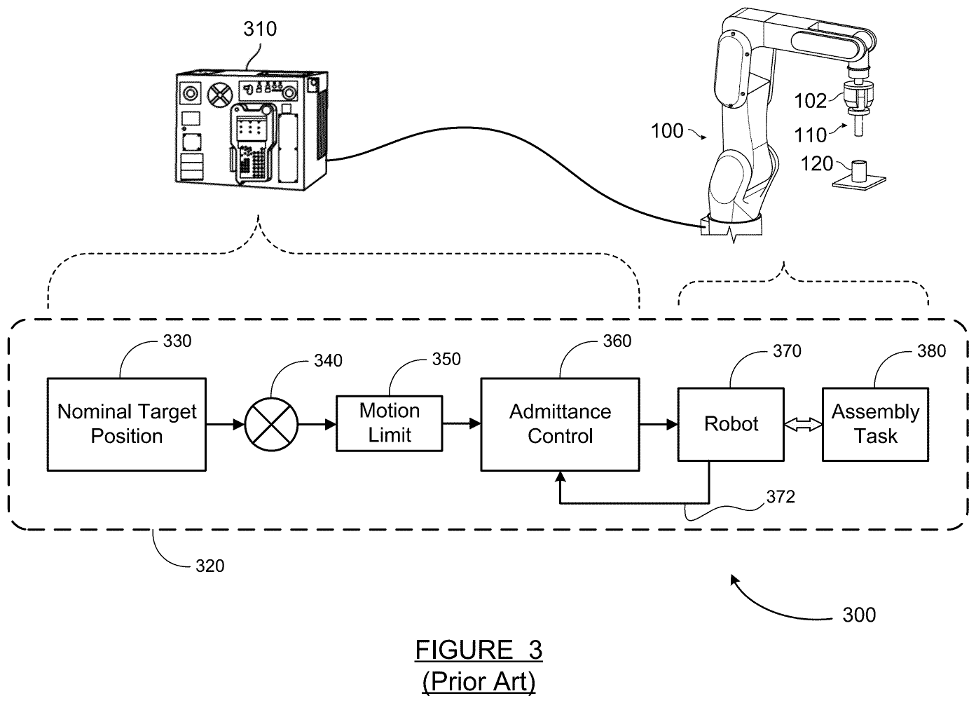

FIG. 3 is a block diagram illustration of a system 300 configured for a robotic assembly operation using a compliance controller (i.e., force or admittance control), as known in the art. In the physical world, a robot controller 310 communicates with a robot such as the robot 100 of FIG. 1. The controller 310 provides joint motion commands to the robot 100 and receives state feedback from the robot 100, as known in the art and discussed below. As illustrated in FIG. 1, the robot 100 has the gripper 102 grasping the first part 110, and the controller 310 provides commands with the objective of assembling the first part 110 with (into) the second part 120.

A block 320 represents the controller 310 and the robot 100 in block diagram form. The controller 310 is configured as a compliance controller, the functions of which are discussed below. A block 330 provides a nominal target position of the first part 110. The nominal target position could be predefined and unchanging for a particular robot workcell, or the nominal target position could be provided by a vision system based on an observed position of the second part 120, which may be moving on a conveyor for example. For the sake of this discussion, it is assumed that the position of the second part 120 in the robot workcell is known, and the nominal target position from the block 320 defines the position of the first part 110 to install it into the second part 120. The nominal target position of the first part 110 may then be transformed to gripper coordinates, which can then be converted to robot joint positions using inverse kinematics in a known manner.

A summing junction 340 is included after the block 330. Although the junction 340 does not have a second input in FIG. 3, a second input may be added in some embodiments. A block 350 defines motion limits of the robot 100. The motion limits ensure that the robot 100 does not take an excessively large motion step during the control process, where excessively large motion could create a hazardous situation or result in forceful contact between the robot 100 and/or the parts 110/120 with each other or with other objects in the workcell. If the difference between the target position and the current position is greater than the motion limit, then the motion limit will prevail and limit the size of the step.

A block 360 includes an admittance control function which interacts with the robot in a block 370 performing the assembly task in a block 380. The blocks 370 and 380 represent the physical actions of the robot 100 as it installs the first part 110 into the second part 120. The robot in the block 370 provides state feedback on a line 372 to the admittance control function in the block 360. The state feedback provided on the line 372 includes robot joint states (position/velocity), along with contact forces and torques. Alternately, position and velocity state data may be provided in Cartesian coordinates, which can readily be converted to joint coordinates, or vice versa, via the transformation calculations described above. A force and torque sensor (not shown) is required in the operation of the robot 100 to measure contact forces between the parts 110 and 120, where the force and torque sensor could be positioned between the robot 100 and the gripper 102, between the gripper 102 and the first part 110, or between the second part 120 and its “ground” (fixing device). The contact force and torque can also be measured from robot joint torque sensors or estimated from other signals such as motor currents.

The admittance control function in the block 360 operates in the following manner, as known in the art and discussed only briefly here. Impedance control (or admittance control) is an approach to dynamic control relating force and position. It is often used in applications where a manipulator interacts with its environment and the force-position relation is of concern. Mechanical impedance is the ratio of force output to motion input. Controlling the impedance of a mechanism means controlling the force of resistance to external motions that are imposed by the environment. Mechanical admittance is the inverse of impedance—it defines the motions that result from a force input. The theory behind the impedance/admittance control method is to treat the environment as an admittance and the manipulator as an impedance.

Using the target position from the junction 340 and the motion limit from the block 350, the admittance control function in the block 360 computes a target velocity (in six degrees of freedom) to move the workpiece from its current position to the target position (or the motion limited step size). The admittance control function then computes a command velocity by adjusting the target velocity with a force compensation term, using an equation such as: V=V_{d}+Kᵥ⁻¹F, where V is the command velocity vector (this equation applies to translational motion), V_{d} is the target velocity vector, Kᵥ⁻¹ is the inverse of an admittance gain matrix, and F is the measured contact force vector from the force sensor fitted to the robot or the workpiece. The vectors all include three translational degrees of freedom in this example. A similar equation is used to compute rotational command velocities ω using contact torque feedback.

The command velocities computed as described above are then converted to command joint velocities \dot{q}_{cmd} for all robot joints by multiplying the inverse of a Jacobian matrix J by the transpose of the command velocities vector, as follows: \dot{q}_{cmd}=J⁻¹[V, wω]^{T}. A low pass filter may also be provided after the computation of the command joint velocities to ensure smoothness and feasibility of the commanded velocities. The computed command joint velocities are provided to the robot, which moves and measures new contact forces, and the target position is again compared to the current position and the velocity calculations are repeated. Using the force feedback and the robot state feedback on the line 372, the admittance control function in the block 360 repeatedly provides motion commands to the robot in the block 370 in attempting to reach the target position from the junction 340.

The elements 330-360 are programmed as an algorithm in the controller 310. The interaction of the controller 310 with the robot 100 occurs via a cable (or wirelessly) in the real world, and this interaction is represented in the block 320 by the forward arrow (motion commands) from the block 360 to the block 370 and the feedback line 372 (joint states and contact forces).

As mentioned earlier, traditional compliance control techniques are not effective for all types of assembly tasks. For example, in tight-tolerance assembly operations, and in cases such as in FIG. 2 where the initial position is significantly offset from the target position, the robot in the block 370 may spend a long time in the feedback loop with the admittance control function in the block 360, and may never ultimately complete the assembly task, including the possibility of part damage in the process. This situation may be somewhat alleviated by fine tuning of the impedance/admittance control parameters, but this is only effective in some situations, and only for a particular workpiece assembly operation.

Another robot control technique which has been developed for assembly and other precision motion applications is visual servoing. In visual servoing, rather than controlling the robot to move a workpiece to a nominal target position at a predefined constant location, the required workpiece movement is dynamically adjusted based on images of the workpiece and the operating environment. As the robot moves the workpiece, new images are provided and the adjusted target position is refined in a feedback control loop.

Like compliance control, visual servoing has been proven effective in some robotic applications. However, visual servoing also has shortcomings—including occlusion in the images, depth inaccuracies when using a 2D camera, processing speed when using a 3D camera, and others—and visual servoing techniques are therefore often unable to meet the challenge of robotic assembly and other precision motion application.

The techniques of the present disclosure have been developed to address the shortcomings of existing visual servoing and compliance control techniques, and are discussed in detail below.

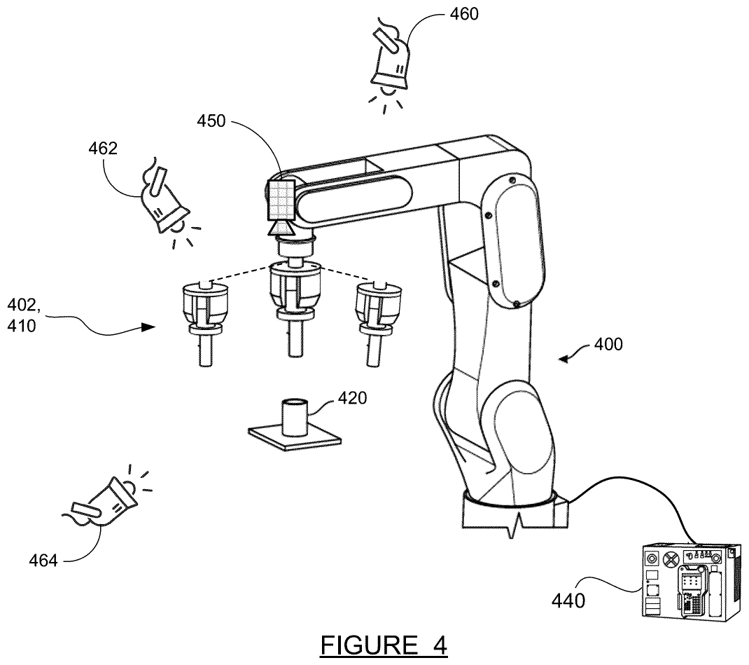

FIG. 4 is an illustration of a system for learning visual pose estimation in a robotic operation, including data collection for training of a pose estimation neural network, according to an embodiment of the present disclosure. A robot 400 is similar to the robot 100 discussed earlier. The robot 400 includes an articulated robot arm with a gripper 402 at the end of the arm. The gripper 402 grasps a workpiece 410 which is to be installed into or assembled with a workpiece 420. The gripper 402 and the workpiece 410 are shown in multiple positions in FIG. 4, for reasons explained below.

The robot 400 is in communication with a controller 440, which controls movement of the robot 400 and also receives data from the robot 400. A camera 450 is mounted on the outer robot arm such that the camera 450 is fixed in orientation relative to the gripper 402. The camera 450 has a field of view which preferably includes the workpiece 410 and the mating workpiece 420 in most of the images as the robot 400 moves. The camera 450 is preferably a two-dimensional (2D) camera with color (i.e., “RGB”) imaging capability. A 2D camera is preferable because 2D camera images are much faster to process than three-dimensional (3D) camera data, and the techniques of the present disclosure eliminate the need for 3D camera data. The camera 450 provides its images to the controller 440, or to a separate computer (not shown) which is also in communication with the controller 440.

A plurality of lights (460, 462, 464) are arranged in the workspace of the robot. The lights 460-464 serve as controllable sources of illumination in the workspace where the robotic operation is being performed. Each of the lights 460-464 may be any type of light fixture deemed suitable for the illumination of the workspace—including wide-dispersion ambient light fixtures (e.g., overhead fluorescent lights), floodlights, etc. The lights 460-464 may simply be the available light fixtures already installed in the building (e.g., factory or warehouse) where the robotic workspace is located. The purpose and operation of the lights 460-464 is discussed further below.

According to the techniques of the present disclosure, the system of FIG. 4 is employed to collect data used for training a pose estimation neural network which, after training, will be used for visual servoing robot control. The data used for training is in the form of a plurality of images from the camera 450, with a robot pose recorded for each of the images. The robot pose which is recorded is the relative pose, in six degrees of freedom, of a tool center point with respect to a target pose (when the workpiece 410 is assembled with the workpiece 420). The images are taken by the camera 450 with the robot 400 configured so that the gripper 402 and the workpiece 410 are in a variety of positions near the target pose, and with the lights 460-464 providing a variety of lighting conditions. Each image along with its corresponding relative pose is recorded by the controller 440 or the separate computer, and this data is used for neural network training. The control of the robot positions, lighting conditions and image capture may be manual or automatic.

By training with a plurality of images, depicting scenes having a variety of relative poses and a variety of lighting conditions, the pose estimation neural network becomes robust to variations in part grasping orientation and starting position, robust to camera calibration parameters, and also robust to variations in lighting conditions and shadows. Details of the neural network training methodology and the subsequent usage of the trained neural network for visual servoing robot control are discussed below.

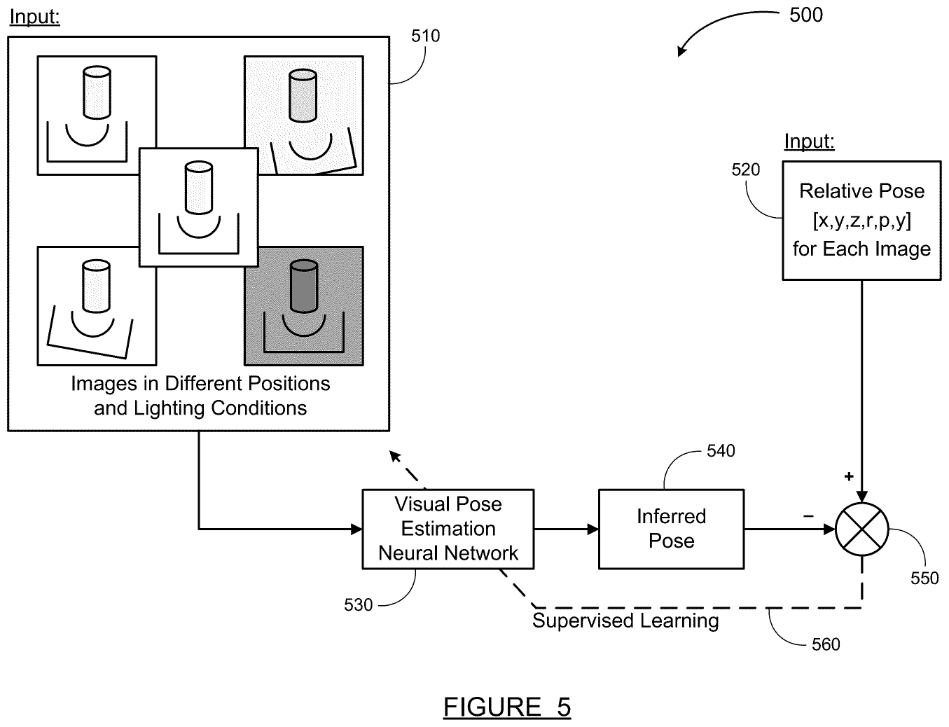

FIG. 5 is a block diagram illustration of a system 500 configured for learning visual pose estimation in a neural network, using the images and relative pose data from the system of FIG. 4, according to an embodiment of the present disclosure. The neural network training system of FIG. 5 may be executed on the controller 440 or the separate computer discussed above with respect to FIG. 4, or yet another computer having access to the input data. Inputs from the system of FIG. 4 are provided in blocks 510 and 520.

The block 510 contains the plurality of images of the workpiece installation scene, from the camera 450. As discussed above, the images in the block 510 are taken from a variety of positions in the vicinity of the target pose, and under a variety of lighting conditions. The positions captured in the images may form a grid pattern or some other geometric or defined pattern surrounding the target pose, in which case the movement of the robot 400 and the triggering of the camera 450 to take each image may be defined in a control program. Alternately, the movement of the robot 400 and the capturing of the images may be manually controlled by an operator (with a teach pendant, for example). In any case, the positional variation covers a range of offset distances in at least the two lateral directions (and optionally vertically) and offset angles about all three axes. For example, the positional variance ranges may be defined as +/−60 mm in the two lateral directions (e.g., X and Y), no variance in the vertical (Z) direction, +/−5 degrees about the pitch and roll axes and +/−10 degrees about the yaw axis (axis of the gripper). The ranges may be selected as suitable for a particular application. Lighting conditions may be varied while the robot remains in a given pose, and/or lighting conditions may be varied from one pose to the next. Lighting condition variation may include any combination of turning on, turning off and/or dimming individual ones of the lights 460-464. An image is taken at each unique combination of robot pose and lighting condition. All of the images are provided in the block 510.

The block 520 contains the relative pose, recorded by the robot controller 440, corresponding with each image in the block 510. The relative pose defines the robot tool center point position relative to the target workpiece position, and was captured for each image (each unique combination of robot pose and lighting condition) as discussed above. The relative pose provided for each image is a vector defining all six degrees of freedom; e.g., x/y/z offset distance, and yaw/pitch/roll offset angle. Each image in the block 510 has its own uniquely identified relative pose vector in the block 520.

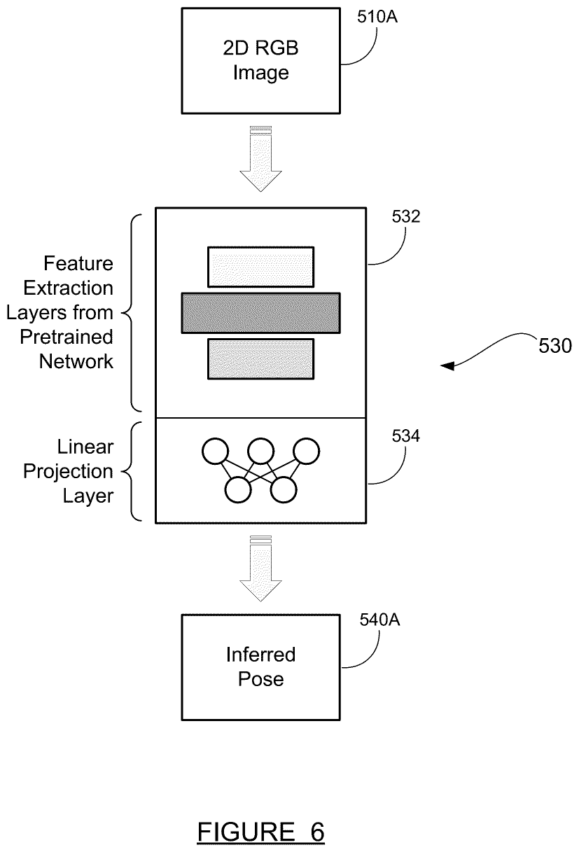

Block 530 is the visual pose estimation neural network. The structure of the neural network 530 is discussed below with respect to FIG. 6. Block 540 is the inferred pose which is output from the neural network 530 for each image. For each image, the relative pose from the block 520 is compared to the inferred pose from the block 540, and a difference is computed as a numeric value at a summing junction 550. The difference value may be a weighted sum of the differences (relative pose minus inferred pose) in the six dimensions (x, y, z, yaw, pitch, roll).

For each image, the difference value from the summing junction 550 is used in a cost function for training of the neural network 530 in a supervised learning process. This is illustrated by a dashed line 560 passing back through the neural network 530. This supervised learning is an automatic process, where a large difference (between the relative pose and the inferred pose) on the line 560 tells the neural network 530 that its pose estimation on that image was not very good, and conversely a small difference on the line 560 tells the neural network 530 that its pose estimation on that image was good. With a sufficient number of training images, the neural network 530 learns which parameter settings provide the most accurate estimate of the relative pose of the workpiece with respect to the installation target pose.

FIG. 6 is a block diagram illustration schematically depicting the structure of the visual pose estimation neural network 530 of FIG. 5, according to an embodiment of the present disclosure. In the preferred embodiment shown in FIG. 6, the visual pose estimation neural network 530 is comprised of a section 532 including layers from a pretrained neural network, and a section 534 which includes a linear projection layer customized to match the task data from the robotic operation.

The section 532 includes several layers of a neural network which has been developed and pretrained to be effective in feature extraction from images. In these neural networks, both the structure (number of layers and nodes, node connectivity, etc.) and preliminary values of the parameters (weighting values) are pretrained for feature extraction effectiveness. Such pretrained neural network packages are available from various commercial and public domain sources. By using a part of a pretrained neural network in the section 532, the training time for the visual pose estimation neural network 530 is dramatically reduced as compared to starting with a “blank slate” neural network architecture.

The linear projection layer in section 534 performs a linear matrix multiplication to project a higher dimensional discrete vector (from the section 532) into a lower dimensional continuous vector. The exact matrix multiplication parameters are learned through the training process.

In FIG. 6, a single one of the images (510A) from the block 510 is provided to the visual pose estimation neural network 530. Using the current parameters in the feature extraction layers section 532 and the linear projection layer 534, the visual pose estimation neural network 530 outputs an inferred pose 540A corresponding to the image 510A. This is exactly as shown previously in FIG. 5. Then, using the cost function based on the difference between the relative pose (corresponding to the image 510A) and the inferred pose 540A, supervised learning training is performed on the neural network 530. This incremental training process is performed for each of the images in the block 510. In the preferred embodiment, only the parameters of the neural network 530 are modified in training (in both the feature extraction layers section 532 and the linear projection layer 534); the structure is not modified in training.

The structure of the visual pose estimation neural network 530 and the corresponding training methodology, depicted in FIGS. 4-6 and described above, has been demonstrated to be advantageous for several reasons. First, the training process is easy and automatic using the data collected as shown in FIG. 4. No manual calibration of the neural network 530 is needed—either in the structure or the parameters, and no physical features need to be identified or selected in the images. Furthermore, no calibration of the camera 450 is required, because any camera calibration or alignment inaccuracies are automatically compensated for in the neural network training process.

In addition, the neural network training and execution are fast. In actual trials, the training of the neural network 530 has been shown to converge to highly accurate pose estimation in only a few minutes on a readily available computing device. This training was performed using a number of training images (in the block 510) in the low hundreds. Once trained, the execution of the neural network 530 (in inference mode) is also very fast—on the order of a few milliseconds. This performance in inference mode is fast enough to use in production robotic operations—where the neural network 530 receives a camera image and infers a relative pose which is used in visual servoing robotic control for placement of a workpiece.

The visual pose estimation neural network 530 also provides results which are accurate (demonstrated at sub-millimeter levels) and are robust to lighting condition changes. This accuracy and robustness are necessary for high precision positioning tasks in real world environments—where shadows and poor/variable lighting conditions are a reality.

The simple and straightforward data collection, and the fast and automatic training, along with the accuracy and robustness of the resulting pose estimations from the trained network, make the visual pose estimation neural network and the associated training methodology discussed above highly effective in visual servoing robotic control applications.

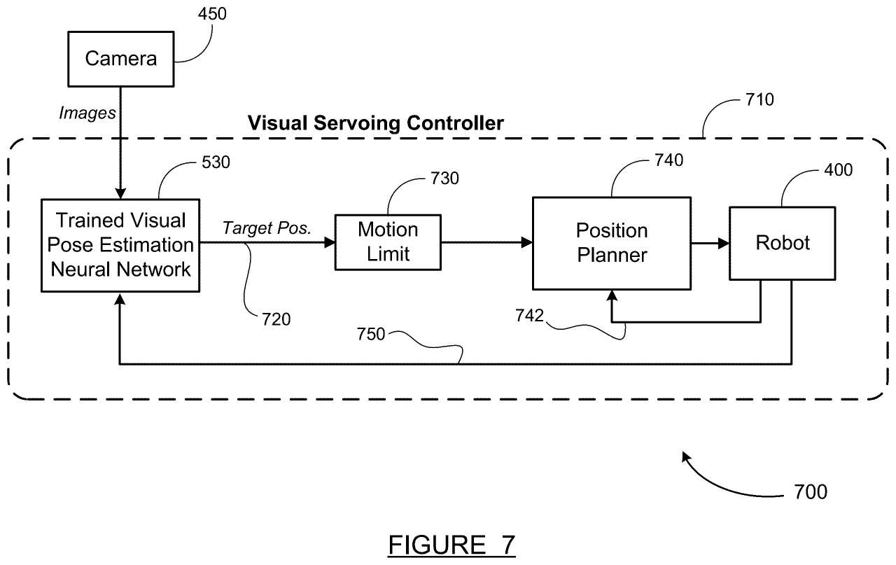

FIG. 7 is a block diagram illustration of a system 700 configured for robotic positioning of a workpiece, using the trained visual pose estimation neural network in a visual servoing controller, according to an embodiment of the present disclosure. A block 710 is configured as a robotic visual servoing controller. The robot 400 (of FIG. 4) is shown in the block 710. The robot and camera in the visual servoing control system of FIG. 7 need not be the same individual devices which were used for data collection in FIG. 4, as long as the type/model of robot, the type of camera and the workpiece positioning application are the same between the data collection system (FIG. 4) and the production system (FIG. 7). The visual servoing controller block 710 may be executed on the controller 440 or a similar robot controller.

The camera 450 (mounted on the robot arm as discussed earlier) provides images of the workpiece positioning scene to the block 710. Specifically, the camera 450 provides images to the visual pose estimation neural network 530 which was previously trained. Upon receiving an image, the trained neural network 530, running in inference mode, outputs an estimated relative target pose as discussed above. Thus, on line 720, the estimated target pose of the workpiece relative to the current position of the robot is provided for processing. The target pose on the line 720 defines where the robot 400 needs to be moved, in order to properly position the workpiece.

The target pose (relative to current position) may be provided to an optional motion limit module 730, which ensures that the robot 400 does not take an excessively large motion step during the control process. The target position, motion limited if appropriate, is provided to a position planner module 740. The position planner module 740 computes robot motions needed to move the workpiece from the current position to the target position. For example, the module 740 may compute a spline function which is designed to move the workpiece from its current position and orientation (in 6 DOF) to the target position and orientation as provided by the neural network 530. From the spline curve trajectory, the position planner module 740 can compute corresponding robot joint motions using inverse kinematics calculations in a known manner.

The position planner module 740 provides robot motion commands to the robot 400 as indicated by the forward arrow. The robot provides state data (e.g., joint positions and velocities) back to the position planner module 740 on a feedback line 742. The feedback control loop from the position planner module 740 to the robot 400 and back on the line 742 may continue for several steps in real time as the robot moves along the computed path (e.g., the spline curve trajectory described above). A feedback loop also exists, on a line 750, back to the pose estimation neural network 530. This is the essence of a visual servoing control system—moving the robot some distance toward a target, then acquiring another image and updating the control commands based on the new image. In the case of the system of FIG. 7, the new image is processed by the pose estimation neural network 530, a new relative target pose is estimated by the neural network 530, and the new target is provided to the position planner module 740 which computes new robot motion commands. This process continues until the robot arrives at the target position and the neural network 530 indicates that the target position is equal to the current position.

If the workpiece positioning or assembly operation is not particularly difficult, the visual servoing controller system of FIG. 7 may complete the operation, release the workpiece and return to a starting location to grasp a new workpiece. However, in very tight tolerance applications, the visual servoing control approach of FIG. 7 may need to be integrated with or followed by a force controller operation in order to complete the workpiece positioning or assembly. Combinations of visual servoing control and compliance control are shown in the following two figures and discussed below.

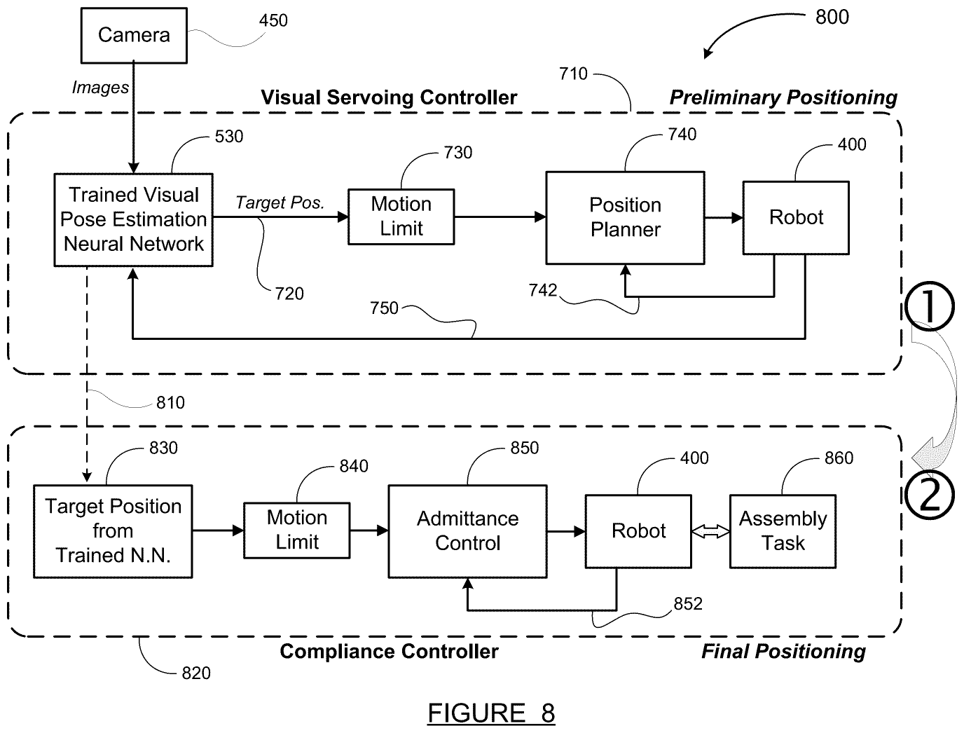

FIG. 8 is a block diagram illustration of a system 800 configured for robotic positioning of a workpiece, using the visual servoing controller of FIG. 7 for preliminary positioning and a compliance controller for final positioning, according to an embodiment of the present disclosure. The system of FIG. 8 may run on the controller 440 or a similar controller. The visual servoing controller in the block 710 is shown in the upper portion of FIG. 8, and operates exactly as described above with respect to FIG. 7—that is, the block 710 receives images from the camera 450, and the visual pose estimation neural network 530 estimates a relative target pose which is used by a position planner to control the robot. Visual servoing control is used to perform a preliminary workpiece positioning in a first step (indicated at \textcircled{1}) in the system of FIG. 8.

Following the preliminary workpiece positioning, a final workpiece positioning (e.g., installation or assembly) is performed in a second overall step (as indicated at \textcircled{2}). The final workpiece positioning is performed using a compliance controller shown in a block 820. The compliance controller in the block 820 receives the target position from the neural network 530 on a line 810. This transfer of the target position from the visual servoing controller block 710 to the compliance controller block 820 is a one-time transfer, indicating what relative positional movement is needed to complete the workpiece placement. After that, the visual servoing controller block 710 is no longer active.

In the compliance controller block 820, the relative target position is received in a block 830. From that point, the compliance controller block 820 operates just as described earlier for the block 320 of FIG. 3. That is, the target position is motion limited if necessary (block 840) and provided to an admittance control block 850 which communicates with the robot 400—providing motion commands to the robot 400 and receiving state feedback (including forces and torques along with robot motions) on a line 852. The assembly task is shown in a block 860, and the interaction of the robot 400 with the physical environment (the workpiece contacting the mating part, with resulting contact forces and torques) is depicted by the double-headed arrow. The compliance controller block 820 operates in the feedback loop (admittance control block 850 and robot 400) until the workpiece is placed in the final target position. There is no feedback loop to the block 830 to determine a new target position in the system of FIG. 8.

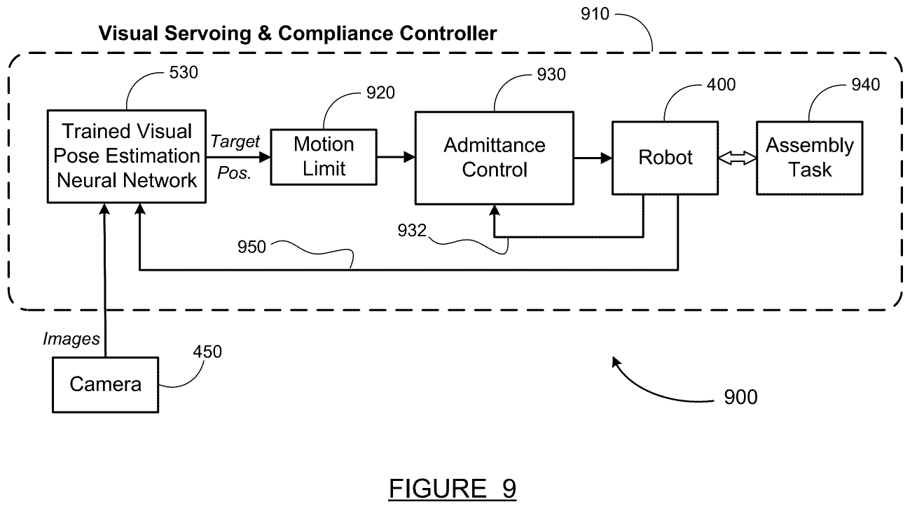

The two-stage control illustrated in FIG. 8 is one embodiment of a system which combines visual servoing control (using the visual pose estimation neural network) with compliance control for precision workpiece placement applications. Another embodiment—where visual servoing control and compliance control are integrated in a nested loop—is illustrated in FIG. 9.

FIG. 9 is a block diagram illustration of a system 900 configured for robotic positioning of a workpiece, using integrated compliance control and visual servoing control with the visual pose estimation neural network, according to an embodiment of the present disclosure. The system of FIG. 9 may run on the controller 440 or a similar controller. An integrated visual servoing and compliance controller is shown in a block 910. The camera 450 provides images of the workpiece positioning scene to the trained visual pose estimation neural network 530, which operates as discussed previously to estimate a relative target position.

The target position from the neural network 530 is motion limited if necessary (block 920) and provided to an admittance control block 930 which communicates with the robot 400—providing motion commands to the robot 400 and receiving state feedback (including forces and torques along with robot motions) on a line 932. The assembly task is shown in a block 940, and the interaction of the robot 400 with the physical environment (the workpiece contacting the mating part, with resulting contact forces and torques) is depicted by the double-headed arrow as before. The admittance control block 930 and the robot 400 operate in an inner feedback loop for some number of cycles, and then the robot position state is provided on an outer feedback loop line 950 to the pose estimation neural network 530. Using a new image from the camera 450 and the actual relative pose on the line 950, the neural network 530 estimates a new relative target pose which is provided to the admittance control block 930.

The system of FIG. 9 provides integrated control which takes advantage of the benefits of visual servoing control using the pose estimation neural network 530 (which is particularly effective for the larger motions when the workpiece is being moved from an initial position toward the target position), and the benefits of compliance control (which is particularly effective for the fine positioning motions needed during tight-tolerance placement of the workpiece, such as when being assembled with a mating part).

Whether used in a robot controller employing purely visual servoing control, or incorporated in a robot controller which also employs compliance control, the visual pose estimation neural network 530 provides the engine for workpiece placement. The visual pose estimation neural network 530 is easily trained using the techniques discussed earlier, is cost-effective, accurate and fast using a 2D camera, and is robust to changing and sub-optimal lighting conditions by virtue of the variations included in the training image set.

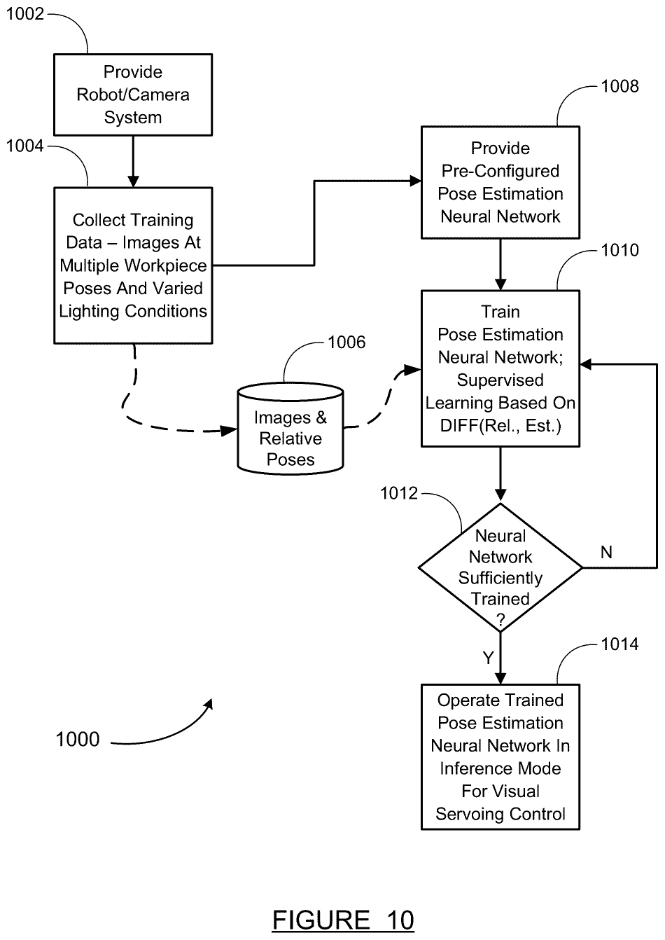

FIG. 10 is a flowchart diagram 1000 of a method for learning visual pose estimation for a robotic operation, including offline training of a neural network using images in different positions and lighting conditions, and online visual servoing using the trained neural network, according to an embodiment of the present disclosure.

At box 1002, a robot/camera system is provided for data collection. This is the system illustrated in FIG. 4, with the robot 400 and the controller 440, along with the setup for installing a first workpiece 410 into a second workpiece 420. This is all arranged in a workcell with the lights 460/462/464 which can be controlled to vary lighting conditions.

At box 1004, training images are collected using the robot/camera system. As described earlier, the robot 400 moves the gripper 402 with the workpiece 410 to various positions in the vicinity of the target position, and lighting conditions are varied while many images are captured. For each image captured, the relative pose of the workpiece with respect to the target pose is also recorded by the controller 440. The images and poses are stored in a file or database 1006. The database 1006 may reside on the controller 440, or optionally may reside on a separate computer (not shown in FIG. 4). The separate computer, for example, may store the training data (the database 1006), and may also be used for the neural network training process.

At box 1008, a pre-configured pose estimation neural network is provided. This is the neural network 530 shown in FIGS. 5 and 6. The neural network 530 is preferably pre-configured with the design shown in FIG. 6 and discussed earlier. At box 1010, the pose estimation neural network is trained in a supervised learning process, using the images and relative pose data from the database 1006. As discussed previously with respect to FIG. 5, the training includes the neural network inferring a relative pose for an image, and a difference between the recorded relative pose and the inferred relative pose being used in a cost function for training the parameters of the neural network, where a large difference is penalized and a small difference is rewarded.

This process described above is carried out repeatedly until a maximum count number is reached, or until the neural network converges to consistently accurate inferred poses—meeting some threshold of difference between the recorded relative pose and the inferred relative pose. At decision diamond 1012, when the neural network performance has not yet converged to a satisfactory level, the process loops back to the box 1010 for a next image. From the decision diamond 1012, when the neural network performance has converged to a satisfactory level, the process moves on to a box 1014.

At the box 1014, the trained pose estimation neural network is used in inference mode for visual servoing control of the robot. This could include any of the control system architectures illustrated in FIGS. 7-9, where the trained visual pose estimation neural network 530 is used in a pure visual servoing control system (FIG. 7), or the neural network 530 is used in visual servoing control for preliminary positioning followed by compliance control for final positioning (FIG. 8), or the neural network 530 is used in an integrated visual servoing/compliance control system (FIG. 9). In all of these system architectures, the trained neural network 530 provides an inferred or computed value of the relative target pose from a most recent camera image. The method steps of FIG. 10 may be performed on the robot controller 440 and optionally other robot controllers and separate computers as outlined above. For example, the neural network training may be performed on a computer which is not a robot controller, and the trained neural network then provided and used in a control module running on a robot controller.

The methods and systems disclosed herein enable simple, automated training of a visual pose estimation neural network, which is then fast and accurate enough to be used in real-time visual servoing robotic control—in combination with compliance control if appropriate. The trained neural network is robust to variations in lighting conditions as a result of the training data image set, and the system employed in both training and inference modes uses a cost-effective 2D camera. In these ways, the disclosed methods and systems provide significant improvement over traditional image-based robotic control systems.

Throughout the preceding discussion, various computers and controllers are described and implied. It is to be understood that the software applications and modules of these computers and controllers are executed on one or more computing devices having a processor and a memory module configured for learning visual pose estimation in robotic operations. In particular, this includes a processor in the robot controller 440 along with the optional separate computer used for data collection in FIG. 4, the computer used for the training process of FIG. 5, and the robot controllers and optional other computers which execute the functions of the visual servoing and compliance controllers—including operation of the visual pose estimation neural network in inference mode—depicted in FIGS. 7-9.

The foregoing discussion discloses and describes merely exemplary embodiments of the present disclosure. One skilled in the art will readily recognize from such discussion and from the accompanying drawings and claims that various changes, modifications and variations can be made therein without departing from the spirit and scope of the disclosure as defined in the following claims.

What is claimed is:

1. A learning visual pose estimation robotic system, said system comprising:
a robot with a gripper configured to perform an operation on a workpiece;
a camera coupled to an outer arm of the robot proximal the gripper, the camera providing images of a workpiece operational scene;
one or more lights illuminating a workspace of the robot; and
at least one computing device in communication with the robot and the camera, the at least one computing device being configured with a neural network, where the neural network is trained for visual pose estimation with a plurality of the images having a variety of workpiece positions and a variety of lighting conditions along with an actual relative pose for each image, and after training the neural network runs in inference mode for visual pose estimation used in visual servoing control of the robot performing the operation.

2. The system according to claim 1 wherein the workpiece operational scene in each image includes at least a portion of the workpiece in the gripper of the robot and a placement target area, and the actual relative pose for each image defines a relative position of the workpiece with respect to a target position as determined from robot joint positions.

3. The system according to claim 1 wherein the at least one computing device is configured with a supervised learning algorithm which trains the neural network for visual pose estimation by computing, for each image of the plurality of images, a difference between an inferred pose from the neural network for the image and the actual relative pose for the image, and applying a cost function which rewards a small difference and penalizes a large difference.

4. The system according to claim 1 wherein the variety of lighting conditions are achieved by individually or collectively turning on, turning off and/or dimming the one or more lights.

5. The system according to claim 1 wherein the neural network has a structure including a plurality of layers pre-configured for image feature extraction and a linear projection layer which receives output from the plurality of layers and provides an inferred pose.

6. The system according to claim 5 wherein parameter values of the neural network are revised during training to improve accuracy of the inferred pose, and the structure is not revised.

7. The system according to claim 1 wherein, in the visual servoing control of the robot, the neural network receives a camera image and computes an inferred relative pose, and a position planning module computes robot joint motions needed to move the workpiece to a target position based on the inferred relative pose.

8. The system according to claim 1 wherein the visual servoing control is used in cooperation with compliance control of the robot performing the operation.

9. The system according to claim 8 wherein the visual servoing control is used to perform a preliminary positioning of the workpiece and the compliance control is subsequently used to perform a final positioning of the workpiece, or the visual servoing control operates in an outer feedback control loop and the compliance control operates in an inner feedback control loop during positioning of the workpiece.

10. The system according to claim 1 wherein the camera is a two-dimensional (2D) camera.

11. The system according to claim 1 wherein the operation is moving the workpiece to a destination location, or fitting the workpiece with or into a second workpiece.

12. The system according to claim 1 wherein the at least one computing device is a robot controller which controls movements of the robot and receives joint state data from the robot, and which also performs training of the neural network.

13. The system according to claim 1 wherein the at least one computing device includes a computer in communication with a robot controller, where the computer receives images from the camera and joint position data from the robot controller and performs training of the neural network, and the robot controller performs the visual servoing control of the robot using the trained neural network.

14. A learning visual pose estimation robotic system, said system comprising:
a robot with a gripper configured to perform an operation on a workpiece;
a camera coupled to an outer arm of the robot proximal the gripper, the camera providing images of a workpiece operational scene;
one or more lights illuminating a workspace of the robot; and
at least one computing device in communication with the robot and the camera,
where the at least one computing device is configured with a supervised learning algorithm which trains a neural network for visual pose estimation using a plurality of the images having a variety of workpiece positions and a variety of lighting conditions along with an actual relative pose for each image, wherein the supervised learning algorithm computes for each image of the plurality of images a difference between an inferred pose from the neural network for the image and the actual relative pose for the image, and uses a cost function to train parameters of the neural network by rewarding a small difference and penalizing a large difference,
and after training the at least one computing device runs the neural network in inference mode for visual pose estimation used in visual servoing control of the robot performing the operation, where the neural network receives a camera image and computes an inferred relative pose, and a position planning module computes robot joint motions needed to move the workpiece to a target position based on the inferred relative pose.

15. A method for learning visual pose estimation in a robotic operation, said method comprising:
providing a robot with a gripper configured to perform an operation on a workpiece, one or more lights illuminating a workspace of the robot, and a camera coupled to an outer arm of the robot proximal the gripper, where the camera is configured to provide images of a workpiece operational scene;
collecting training data, by a computing device in communication with the robot and the camera, where the training data includes a plurality of the images having a variety of workpiece positions and a variety of lighting conditions along with an actual relative pose for each image;
training the neural network for visual pose estimation with the training data; and
running the neural network in inference mode for visual pose estimation used in visual servoing control of the robot performing the operation.

16. The method according to claim 15 wherein the workpiece operational scene in each image includes at least a portion of the workpiece in the gripper of the robot and a placement target area, and the actual relative pose for each image defines a relative position of the workpiece with respect to a target position as determined from robot joint positions.

17. The method according to claim 15 wherein the computing device is configured with a supervised learning algorithm which trains the neural network for visual pose estimation by computing, for each image of the plurality of images, a difference between an inferred pose from the neural network for the image and the actual relative pose for the image, and applying a cost function which rewards a small difference and penalizes a large difference.

18. The method according to claim 15 wherein the variety of lighting conditions are achieved by individually or collectively turning on, turning off and/or dimming the one or more lights.

19. The method according to claim 15 wherein the neural network has a structure including a plurality of layers pre-configured for image feature extraction and a linear projection layer which receives output from the plurality of layers and provides an inferred pose, and where parameter values of the neural network are revised during training to improve accuracy of the inferred pose.

20. The method according to claim 15 wherein, in the visual servoing control of the robot, the neural network receives a camera image and computes an inferred relative pose, and a position planning module computes robot joint motions needed to move the workpiece to a target position based on the inferred relative pose.

21. The method according to claim 15 wherein the visual servoing control is used in cooperation with compliance control of the robot performing the operation.

22. The method according to claim 21 wherein the visual servoing control is used to perform a preliminary positioning of the workpiece and the compliance control is subsequently used to perform a final positioning of the workpiece, or the visual servoing control operates in an outer feedback control loop and the compliance control operates in an inner feedback control loop during positioning of the workpiece.

23. The method according to claim 15 wherein the operation is moving the workpiece to a destination location, or fitting the workpiece with or into a second workpiece.
